(19) United States
(12) Patent Application Publication
(10) Pub. No.: US 2016/0253804 A1
(43) Pub. Date: Sep. 1, 2016

(54) ASSISTING APPARATUS FOR ASSISTING IN REGISTERING AN IMAGING DEVICE WITH A POSITION AND SHAPE DETERMINATION DEVICE

(71) Applicant: KONINKLIJKE PHILIPS N.V., Eindhoven (NL)

(72) Inventor: AHMET EKIN, EINDHOVEN (NL)

(21) Appl. No.: 15/028,463

(22) PCT Filed: Oct. 21, 2014
(86) PCT No.: PCT/EP2014/072475

§ 371 Date: Apr. 11, 2016

(30) Foreign Application Priority Data
Oct. 30, 2013 (EP) 13190767.7

(51) Int. Cl. G06T 7/00; G09B 23/28

(52) U.S. Cl. CPC G06T 7/0026; G06T 7/0044; G09B 23/286; G06T 2207/10081; G06T 2207/20092

(57) ABSTRACT

The invention relates to an assisting apparatus for assisting in registering an imaging device like an x-ray C-arm device (2) with a position and shape determination device (15) like an OSS device. The apparatus comprises a database (16) providing registration values depending on registration image data sets and/or registration position and shape data sets, wherein the registration values are indicative of registration accuracies and/or registration times. The apparatus further comprises an evaluation unit (18) for evaluating the registration accuracy and/or the registration time based on an input registration image data set and/or position and shape data set by using the database. Thus, before, during and/or after a registration procedure the registration accuracy and/or the registration time can be evaluated, in order to assist in registering the imaging device with the position and shape determination device.

### FIELD OF THE INVENTION

The invention relates to an assisting apparatus, method and computer program for assisting in registering an imaging device with a position and shape determination device. The invention relates further to a database generation apparatus, method and computer program for generating a database to be used by the assisting apparatus, and to a teaching apparatus, method and computer program for teaching a user in registering the imaging device with the position and shape determination device. The invention also relates to an interventional system for applying an interventional procedure to a living being.

### BACKGROUND OF THE INVENTION

WO 2013/001388 A1 discloses a method for providing a live three-dimensional image of a body lumen. The three-dimensional shape of a flexible surgical tool within the body lumen is determined by using optical shape sensing, and an x-ray image of the body lumen is taken, wherein at least one of the body lumen and the surgical tool is radiopaque. The determined three-dimensional surgical tool shape is registered with the x-ray image.

In interventional procedures a position and shape of an interventional instrument like a catheter may be determined by optical shape sensing (OSS), while the interventional instrument is navigated within a person. During the interventional procedure generally also x-ray projection images are generated by using an x-ray projection system. In order to show the determined position and shape of the interventional instrument on the x-ray projection images, the position and shape determination device is registered with the x-ray projection system. This registration may be inaccurate and/or may take a relatively long time.

### SUMMARY OF THE INVENTION

It is an object of the present invention to provide an assisting apparatus, method and computer program for assisting in registering an imaging device with a position and shape determination device, which allow for a more accurate and/or a faster registration. It is a further object of the present invention to provide a database generation apparatus, method and computer program for generating a database to be used by the assisting apparatus and to provide a teaching apparatus, method and computer program for teaching a user in registering an imaging device with the position and shape determination device. It is a further object of the present invention to provide an interventional system for applying an interventional procedure to a living being, wherein the interventional system comprises the assisting apparatus.

In a first aspect of the present invention an assisting apparatus for assisting in registering an imaging device with a position and shape determination device is presented, the imaging device being adapted to generate a registration image of a first object, while the first object is in a registration position and has a registration shape, the position and shape determination device being adapted to determine the registration position and the registration shape of the first object, wherein the assisting apparatus comprises:

a registration input providing unit for providing a registration image data set being indicative of a registration image showing the first object and/or for providing a registration position and shape data set being indicative of a registration position and shape of the first object,

a database for providing registration values depending on registration image data sets being indicative of registration images showing a registration object having the same spatial configuration as the first object and/or registration position and shape data sets being indicative of registration positions and shapes of the registration object, wherein the registration values are indicative of the registration accuracy and/or the time required for the registration, if a registration image of the registration object in accordance with the respective registration image data set and/or a registration position and shape of the registration object in accordance with the respective position and shape data set is used for the registration,

an evaluation unit for evaluating the registration accuracy and/or the time required for the registration based on registration values provided by the database depending on the provided registration image data set being indicative of the registration image showing the first object and/or the provided registration position and shape data set being indicative of the registration position and shape of the first object.

Since the evaluation unit is adapted to evaluate the registration accuracy and/or the time required for the registration based on the registration values provided by the database and based on the provided registration image data set being indicative of the registration image showing the first object and/or the provided registration position and shape data set being indicative of the registration position and shape of the first object, a measure for the quality of the registration can be provided, which might be performed based on a) a registration image showing the first object and being in accordance with the provided registration image data set and/or b) a registration position and shape of the first object being in accordance with the provided registration position and shape data set. Thus, it can be determined how accurate the registration is or how much time the registration takes, if the registration is based on the registration image, which is in accordance with the provided registration image data set, and/or the registration position and shape, which is in accordance with the provided registration position and shape data set. This information can be used for assisting in registering the imaging device with the position and shape determination device such that the registration accuracy is increased and/or the registration time is decreased.

The first object is preferentially a longish object like a longish interventional instrument. For instance, it might be a catheter or a guidewire. The imaging device is preferentially an x-ray projection device and the position and shape determination device is preferentially an OSS determination device.

A registration image data set may include one or several registration images showing the first object or the registration object, respectively, and/or imaging parameters defining the generation of the respective registration image like an acquisition direction, if the imaging device is an x-ray projection device, an amount of radiation used for generating the respective registration image, et cetera. A registration position and shape data set may include a position data set defining positions of several parts of the first object or the registration object, respectively, wherein these positions of the different parts define the position and shape of the first object or the registration object, respectively. Alternatively or in addition, the registration position and shape data set can include position and shape parameters being indicative of the determination, particularly influencing the determination, of the registration position and shape like the stability of the registration position and shape, jitter, twist, a possible motion of the first object or registration object, respectively, during the determination, et cetera. After the imaging device has been registered with the position and shape determination device, an image of the first object generated by the imaging device is registered with a position and shape of the first object determined by the position and shape determination device.

In an embodiment the evaluation unit is further adapted to determine a recommended registration image data set and/or a recommended registration position and shape data set based on the database such that the evaluated registration accuracy is increased and/or the evaluated time required for the registration is decreased. Thus, the assisting apparatus may not only be adapted to evaluate the provided registration image data set and/or the provided registration position and shape regarding a corresponding registration result, but the assisting apparatus may also be adapted to recommend a registration image data set and/or a registration position and shape data set, which leads to a better registration result, thereby improving the assisting in registering the imaging device with the position and shape determination device.

The assisting apparatus preferentially further comprises an output unit for outputting the determined recommended registration image data set and/or the determined recommended registration position and shape data set to a user, in order to allow the user to use the determined recommended registration image data set and/or the determined recommended registration position and shape data set for the registration.

The database preferentially comprises registration image data sets being indicative of registration images showing the registration object and/or registration position and shape data sets being indicative of the registration position and shape of the registration object, wherein the registration values are assigned to the registration image data sets and/or the registration position and shape data sets, wherein the evaluation unit is adapted to determine a recommended registration image data set and/or a recommended registration position and shape data set by a) determining a group of registration image data sets and/or of registration position and shape data sets of the database, wherein the group includes registration image data sets and/or registration position and shape data sets to which registration values have been assigned being larger than a predefined threshold, b) determining the registration image data set and/or the registration position and shape data set of the determined group being most similar to the registration image data set and/or to the registration position and shape data set provided by the registration input providing unit, and c) recommending the determined registration image data set and/or the recommended registration position and shape data set. This allows determining the recommended registration image data set and/or the recommended registration position and shape data set fast in a relatively simple way. The most similar registration image data set and/or registration position and shape data set of the determined group may be determined by applying a similarity measure to i) the provided registration image data set and/or the provided registration position and shape data set and ii) to the registration image data sets and/or registration position and shape data sets of the group.

The evaluation unit may be adapted to output the determined recommended registration image data set and/or the determined recommended registration position and shape data set to an imaging control unit for controlling the imaging device and/or to a position and shape control unit for controlling the position and shape of the first object, respectively, in order to allow the imaging control unit to control the imaging device and/or to allow the position and shape control unit to control the position and shape of the first object in accordance with the determined recommended registration image data set and/or recommended registration position and shape data set for the registration. This allows for an automatic control of the imaging device and/or of the position and shape of the first object such that an improved registration between the imaging device and the position and shape determination device can be obtained.

In an embodiment the evaluation unit is adapted to determine several recommended registration image data sets and/or several recommended position and shape data sets of the first object based on the database such that the evaluated registration accuracy is increased and/or the registration time is decreased, wherein the determined recommended registration image data sets and/or the determined recommended registration position and shape data sets are shown on a display to a user and wherein the evaluation unit further provides a user interface for allowing the user to select a recommended registration image data set and/or a recommended registration position and shape data set, wherein the selected recommended registration image data set and/or the selected recommended registration position and shape data set are provided to an imaging control unit for controlling the imaging device and/or to a position and shape control unit for controlling the position and shape of the first object, respectively, in order to allow the imaging control unit to control the imaging device and/or to allow the position and shape control unit to control the position and shape of the first object in accordance with the selected recommended registration image data set and/or with the selected recommended registration position and shape data set. This allows for a semi-automatic control of the imaging device and/or of the position and shape of the first object such that the registration can be improved.

It is preferred that the first object is adapted to be introduced into a second object, wherein the assisting apparatus further comprises a structural information providing unit for providing structural information of the second object, wherein the evaluation unit is adapted to determine the recommended registration image data set and/or the recommended registration position and shape data set also depending on the provided structural information. For instance, the recommended registration image data set and/or the recommended registration position and shape data set can be adapted such that the first object is locatable within the second object and the evaluated accuracy is increased. Considering also the structural information while determining the recommendations can further improve the quality of the recommendations and, thus, of the registration performed in accordance with the recommendations. The structural information is, for instance, a computed tomography (CT) image or another image showing the inner structure of the second object.

In an embodiment the database is adapted such that the registration values can be provided further depending on a registration parameter, wherein the registration input providing unit is adapted to also provide the registration parameter and the evaluation unit is adapted to evaluate the accuracy of registering the imaging device and the position and shape determination device to each other also based on the provided registration parameter. Considering also the registration parameter while evaluating the accuracy and/or the speed of registering the imaging device and the position and shape determination device to each other can further improve the quality of this evaluation, which in turn can lead to a further improved assisting in registering the imaging device with the position and shape determination device.

The registration parameter may be a parameter being indicative of the first object and/or of the second object, if the first object should be introduced into the second object, and/or of a kind of user inputs for identifying the first object in a registration image in accordance with the registration image data set, if the registration is based on a detection of the first object in the registration image depending on the user inputs. The registration parameter defines, for instance, whether the first object is a catheter or a guidewire, whether the second object is a certain organ of a living being, i.e. of a person or of an animal, or another part of the living being, the number of user inputs on the registration image and/or the distance between the user inputs on the registration image, et cetera.

The evaluation unit can also be adapted to determine a recommended registration parameter based on the database such that the evaluated registration accuracy is increased and/or the evaluated registration time is decreased. The recommendations can depend on one or several registration parameters. Also considering the registration parameters while determining the recommendations can further improve the quality of the recommendations and, thus, finally the accuracy and/or speed of registering the imaging device and the position and shape determination device to each other.

In a further aspect of the present invention a database generation apparatus for generating a database to be used by the assisting apparatus as defined in claim 1 is presented, wherein the database generation apparatus comprises:

a registration position and shape data set providing unit for providing a registration position and shape data set and for providing a registration position and shape of a registration object, which is determined by a position and shape determination device and which is in accordance with the provided registration position and shape data set,

a registration image data set providing unit for providing a registration image data set and for providing a registration image, which is generated by an imaging device and which is in accordance with the registration image data set, wherein the registration image shows the registration object, while the registration object has the registration position and shape,

a registration value determination unit for determining a registration value based on the registration of the provided registration image and the provided registration position and shape, wherein the registration value is indicative of the registration accuracy and/or the time required for the registration, and

a database generation unit for generating the database based on the determined registration value, the registration image data set and/or the registration position and shape data set.

The provided registration position and shape data set may already comprise the registration position and shape such that with providing the registration position and shape data set also the registration position and shape is provided. If in an embodiment the registration position and shape data set does not comprise the registration position and shape, but only position and shape parameters being indicative of the position and shape determination, the registration position and shape data set providing unit may be adapted to provide a registration position and shape in accordance with the position and shape parameters of the registration position and shape data set. For instance, the registration position and shape data set providing unit can provide a corresponding stored registration position and shape. Moreover, the provided registration image data set may already comprise the registration image such that with providing the registration image data set also the registration image is provided. If in an embodiment the registration image data set does not comprise the registration image, but only imaging parameters being indicative of the generation of the registration image, the registration image data set providing unit may be adapted to provide a registration image in accordance with the imaging parameters of the registration image data set. For instance, the registration image data set providing unit can provide a corresponding stored registration image.

The database generation apparatus may be adapted to generate the database based on one or several determined registration values, one or several registration image data sets and/or one or several registration position and shape data sets. The database generation apparatus may be adapted to update an already existing database based on one or several registration values, one or several registration image data sets and/or one or several registration position and shape data sets. In an embodiment the database generation apparatus may be adapted to generate the database from scratch.

The registration value determination unit may be adapted to apply a similarity measure to the registered registration image and to the registered registration position and shape and to determine the registration value based on the similarity measure. Moreover, the registration value determination unit may be adapted to show the registration result on a display, to provide a user interface allowing a user to input similarity information being indicative of a degree of similarity between the registered registration image and the registered registration position and shape and to determine the registration value based on the input similarity information.

In another aspect of the present invention a teaching apparatus for teaching a user in registering an imaging device with a position and shape determination device is presented, the imaging device being adapted to generate a registration image of a first object, while the first object is in a registration position and has a registration shape, the position and shape determination device being adapted to determine the registration position and the registration shape of the first object, wherein the teaching apparatus comprises:

a database for providing registration values depending on registration image data sets being indicative of registration images showing a registration object having the same spatial configuration as the first object and/or registration position and shape data sets being indicative of registration position and shapes of the registration object, wherein the registration values are indicative of the registration accuracy and/or the time required for the registration, if a registration image of the registration object in accordance with the respective registration image data set and/or a registration position and shape of the registration object in accordance with the respective position and shape data set is used for the registration,

an output determining unit for determining at least one registration image data set and/or at least one registration position and shape data set to be output depending on a registration value provided for the at least one registration image data set and/or the at least one registration position and shape data set.

In another aspect of the present invention an interventional system for applying an interventional procedure to a living being is presented, wherein the interventional system comprises:

an interventional instrument to be introduced into the living being for applying the interventional procedure,

an imaging device for imaging the interventional instrument within the living being,

a position and shape determination device for determining the position and shape of the interventional instrument within the living being, and

an assisting apparatus for assisting in registering the imaging device and the position and shape determination device to each other as defined in claim 1, wherein the interventional instrument is the first object.

In a further aspect of the present invention an assisting method for assisting in registering an imaging device with a position and shape determination device is presented, the imaging device being adapted to generate a registration image of a first object, while the first object is in a registration position and has a registration shape, the position and shape determination device being adapted to determine the registration position and the registration shape of the first object, wherein the assisting method comprises:

providing a registration image data set being indicative of a registration image showing the first object and/or for providing a registration position and shape data set being indicative of a registration position and shape of the first object by a registration input providing unit,

providing a database for providing registration values depending on registration image data sets being indicative of registration images showing a registration object having the same spatial configuration as the first object and/or registration position and shape data sets being indicative of registration positions and shapes of the registration object, wherein the registration values are indicative of the registration accuracy and/or the time required for the registration, if a registration image of the registration object in accordance with the respective registration image data set and/or a registration position and shape of the registration object in accordance with the respective position and shape data set is used for the registration,

evaluating the registration accuracy and/or the time required for the registration based on registration values provided by the database depending on the provided registration image data set being indicative of the registration image showing the first object and/or the provided registration position and shape data set being indicative of the registration position and shape of the first object by an evaluation unit.

In another aspect of the present invention a database generation method for generating a database to be used by the assisting apparatus as defined in claim 1 is presented, wherein the database generation method comprises:

providing a registration position and shape data set and a registration position and shape of a registration object, which is determined by a position and shape determination device and which is in accordance with the provided registration position and shape data set, by a registration position and shape data set providing unit,

providing a registration image data set and a registration image, which is generated by an imaging device and which is in accordance with the registration image data set, by a registration image data set providing unit, wherein the registration image shows the registration object, while the registration object has the registration position and shape,

registering the provided registration image and the provided registration position and shape to each other by a registration unit,

determining a registration value based on the registration by a registration value determination unit, wherein the registration value is indicative of the registration accuracy and/or the time required for the registration, and

generating the database based on the determined registration value, the registration image data set and/or the registration position and shape data set by a database generation unit.

In a further aspect of the present invention a teaching method for teaching a user in registering an imaging device with a position and shape determination device is presented, the imaging device being adapted to generate a registration image of a first object, while the first object is in a registration position and has a registration shape, the position and shape determination device being adapted to determine the registration position and the registration shape of the first object, wherein the teaching method comprises:

providing a database for providing registration values depending on registration image data sets being indicative of registration images showing a registration object having the same spatial configuration as the first object and/or registration position and shape data sets being indicative of registration position and shapes of the registration object, wherein the registration values are indicative of the registration accuracy and/or the time required for the registration, if a registration image of the registration object in accordance with the respective registration image data set and/or a registration position and shape of the registration object in accordance with the respective position and shape data set is used for the registration,

determining at least one registration image data set and/or at least one registration position and shape data set to be output depending on a registration value provided for the at least one registration image data set and/or the at least one registration position and shape data set by an output determining unit.

In another aspect of the present invention an assisting computer program for assisting in registering an imaging device with a position and shape determination device is presented, the imaging device being adapted to generate a registration image of a first object, while the first object is in a registration position and has a registration shape, the position and shape determination device being adapted to determine the registration position and the registration shape, wherein the assisting computer program comprises program code means for causing an assisting apparatus as defined in claim 1 to carry out the steps of the assisting method as defined in claim 10, when the assisting computer program is run on a computer controlling the assisting apparatus.

In a further aspect of the present invention a database generation computer program for generating a database to be used by the assisting apparatus as defined in claim 1 is presented, wherein the database generation computer program comprises program code means for causing a database generation apparatus as defined in claim 8 to carry out the steps of the database generation method as defined in claim 11, when the database generation computer program is run on a computer controlling the database generation apparatus.

In another aspect of the present invention an teaching computer program for teaching a user in registering an imaging device with a position and shape determination device is presented, the imaging device being adapted to generate a registration image of a first object, while the first object is in a registration position and has a registration shape, the position and shape determination device being adapted to determine the registration position and the registration shape, wherein the teaching computer program comprises program code means for causing a teaching apparatus as defined in claim 8 to carry out the steps of the teaching method as defined in claim 12, when the teaching computer program is run on a computer controlling the teaching apparatus.

It shall be understood that the assisting apparatus of claim 1, the database generation apparatus of claim 7, the teaching apparatus of claim 8, the interventional system of claim 9, the assisting method of claim 10, the database generation method of claim 11, the teaching method of claim of claim 12, the assisting computer program of claim 13, the database generation computer program of claim 14 and the teaching computer program of claim 15 have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily an interventional system for applying an interventional procedure to a person,

FIG. 2 shows a flowchart exemplarily illustrating an embodiment of an assisting method for assisting in registering an imaging device with a position and shape determination device,

FIG. 3 shows a flowchart exemplarily illustrating an embodiment of a database generation method for generating a database to be used by an assisting apparatus of the interventional system,

FIG. 4 shows a flowchart exemplarily illustrating an embodiment of a teaching method for teaching a user in registering the imaging device with the position and shape determination device, and

FIG. 5 illustrates exemplarily a visualization of registration positions and shapes of the database.

### DETAILED DESCRIPTION OF EMBODIMENTS

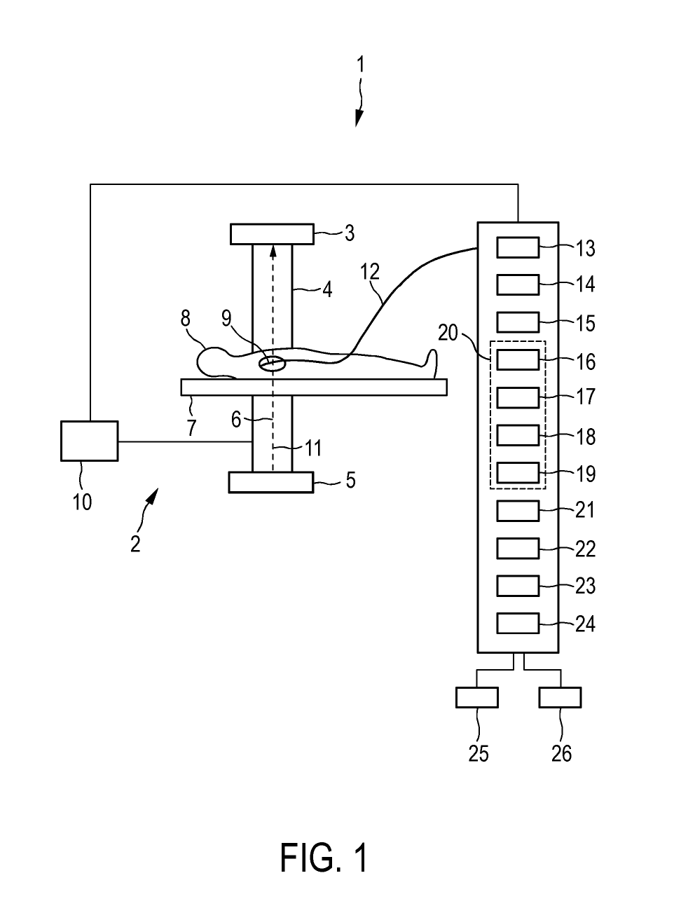

FIG. 1 shows schematically and exemplarily an embodiment of an interventional system for applying an interventional procedure like a cardiac ablation procedure or another interventional procedure to a person 8 lying on a support means like a person table 7. The interventional system 1 comprises a catheter 12 which can be navigated to a desired region 9 within the person 8 by using a navigation unit 13. The catheter 12 can comprise several portions, which are connected by hinges such that the portions are pivotable with respect to each other by using wires connected to the respective portions. In particular, one end of the respective wire may be connected to a respective portion of the catheter 12 and the other end of the respective wire may be connected to a respective motor of the navigation unit 13 such that the different portions of the catheter 12 can be pivoted with respect to each other via the wires and the motors in the navigation unit 13. The navigation unit 13 can comprise at least two further motors for translating the entire catheter 12 and for rotating the entire catheter 12. In particular, for translating and rotating the entire catheter 12 the navigation unit 13 may comprise a mechanical fixture for clamping the catheter 12, wherein the at least two further motors may be adapted to translate the mechanical fixture along a rail and to rotate the mechanical fixture. As an alternative to rotating the mechanical fixture, the navigation unit 13 may be configured such that the catheter 12 is rotated within the mechanical fixture by using at least one of the further motors. Generally, mechanical configurations of known robotic systems can be used for modifying the position and shape of the catheter like the mechanical configuration of the Magellan robotic system from the company Hansen. The interventional system further comprises an input unit 25 like a keyboard, a computer mouse, a touch pad, a joystick, et cetera, in order to allow a user to navigate the catheter 12 via the navigation unit 13. In other embodiments the catheter 12 may be positioned and shaped manually by a user without using a robotic system. For instance, a guidewire may firstly be inserted into the person 8, whereupon the catheter may be moved over the guidewire, wherein the position and shape of the catheter substantially follows the position and shape of the guidewire.

In this embodiment the catheter 12 is adapted to apply energy to an inner part of the person 8. For instance, the tip of the catheter 12 can comprise an ablation electrode for ablating cardiac tissue within the heart 9 of the person 8. The corresponding energy, which might by radio frequency energy, can be provided by an energy providing unit 14. In other embodiments the catheter may be adapted to perform another procedure like a sensing procedure or like a procedure treating another part of the person 8. Moreover, in other embodiments instead of the catheter another interventional instrument may be used.

The catheter 12 comprises an OSS fiber and the interventional system 1 further comprises a position and shape determination device 15 for determining the position and shape of the catheter 12 by OSS. For determining the position and shape of the catheter 12 known OSS techniques can be used like the OSS techniques disclosed in U.S. Pat. No. 7,772,541 B2, which is herewith incorporated by reference.

The interventional system 1 further comprises an imaging device 2 being, in this embodiment, an x-ray projection system. The x-ray projection system 2 comprises an x-ray source 5 emitting x-rays 11 for traversing the person 8 and an x-ray detector 3 for detecting the x-rays 11 after having traversed the person 8. Detection values being indicative of the detected x-rays 11 are provided to an imaging control unit 10, which is adapted to generate x-ray projection images based on the received detection values. The x-ray source 5 and the x-ray detector 3 are attached to opposing ends of a C-arm 4, which is rotatable around the person 8, in order to allow for the generation of x-ray projection images in different acquisition directions.

The interventional system 1 further comprises an assisting apparatus 20 for assisting in registering the x-ray projection system 2 with the position and shape determination device 15. For the registration a registration image of the catheter 12 is generated, while the catheter 12 is in a registration position and has a registration shape, wherein the registration position and the registration shape are determined by the position and shape determination device 15.

The assisting apparatus 20 comprises a database 16 for providing registration values depending on registration image data sets being indicative of registration images showing a registration object having the same spatial configuration as the catheter 12 and/or registration position and shape data sets being indicative of registration positions and shapes of the registration object, wherein the registration values are indicative of the registration accuracy and/or the time required for the registration, if a registration image of the registration object in accordance with the respective registration image data set and/or a registration position and shape of the registration object in accordance with the respective position and shape data set is used for the registration. In this embodiment the database 16 comprises registration image data sets, registration position and shape data sets and combinations of a registration image data set and a registration position and shape, wherein to each registration image data set, to each registration position and shape data set and to each combination of a registration image data set and a registration position and shape data set a corresponding registration value is assigned.

The assisting apparatus 20 further comprises a registration input providing unit 17 for providing a registration image data set being indicative of the registration image showing the catheter 12 and/or for providing a registration position and shape data set being indicative of the registration position and shape of the catheter 12. The registration input providing unit 17 can be a storing unit, in which a registration image data set generated by the x-ray projection system 2 is stored and from which the stored registration image data set can be retrieved for providing the same. The storing unit can also be adapted to store a registration position and shape data set determined by the position and shape determination device 15 and to retrieve the stored registration position and shape for providing the same. The registration input providing unit 17 can also be a receiving unit for receiving a registration image data set from the x-ray projection system 2 and/or a registration position and shape data set from the position and shape detection device 15 and to provide the received registration image data set and/or registration position and shape data set, respectively. The registration input providing unit 17 is preferentially adapted to provide the registration image data set and/or the registration position and shape data set based on a registration image which has been generated by a user using the imaging device 2 and/or a registration position and shape of the catheter 12, which has been determined, after the user has arranged the catheter 12 in this position and shape, respectively.

The assisting apparatus 20 further comprises an evaluation unit 18 for evaluating the registration accuracy and/or the time required for the registration based on registration values provided by the database 16 depending on the provided registration image data set being indicative of the registration image showing the catheter 12 and/or the provided registration position and shape data set being indicative of the registration position and shape of the catheter 12. The evaluation unit 18 is preferentially further adapted to determine a recommended registration image data set and/or a recommended registration position and shape data set based on the database 16 such that the evaluated registration accuracy is increased and/or the evaluated time required for the registration is decreased.

In this embodiment the registration values assigned to the registration image data sets, registration position and shape data sets and combinations of a registration image data set and a registration position and shape data set are directly indicative of the corresponding registration accuracy and registration time. Thus, a large registration value corresponds to a preferred registration image data set, registration position and shape data set or combination of a registration image data set and a registration position and shape data set, respectively, in terms of registration accuracy and registration time. The evaluation unit 18 can evaluate the registration accuracy and the registration time of a provided registration image data set, a provided registration position and shape data set and a provided combination of a registration image data set and a registration position and shape data set based on the respective assigned registration value. For instance, the evaluation result can directly be the registration value assigned to the provided registration image data set, registration position and shape data set or combination of a registration image data set and a registration position and shape data set. The respective registration value can also be further processed for evaluating the registration accuracy and the registration time. For example, the respective registration value can be compared with a predefined threshold, wherein, if the respective registration value is larger than the predefined threshold, the provided registration image data set, the provided registration position and shape data set or the provided combination of a registration image data set and a registration position and shape data set can be evaluated as being “good” and, if the respective registration value is below the predefined threshold, the provided registration image data set, the provided registration position and shape data set or the provided combination of a registration image data set and a registration position and shape data set can be evaluated as being “bad”.

If the provided registration image data set, registration position and shape data set or combination of a registration image data set and a registration position and shape data set is not stored in the database, from the database the closest registration image data set, registration position and shape data set or combination of a registration image data set and a registration position and shape data set, respectively, can be determined by using a similarity measure, wherein the registration value assigned to the determined closest item of the database can be used for determining the registration accuracy and/or registration time. The similarity measure can be based on, for instance, a distance measure applied to the catheter or the registration object, respectively, visible in a registration image of the provided registration image data set and a registration image of a registration image data set stored in the database. A distance-based similarity measure may also be used to find the closest registration position and shape within the database.

For determining a recommended registration image data set and/or a recommended registration position and shape data set the evaluation unit 18 can be adapted to determine a group of registration image data sets and/or of registration position and shape data sets, respectively, of the database 16, wherein the group includes registration image data sets and/or registration position and shape data sets to which registration values have been assigned being larger than a predefined threshold. The group may comprise only registration image data sets, only registration position and shape data sets or combinations of a registration image data set and a registration position and shape data set. The registration image data sets, the registration position and shape data sets or the combinations of a registration image data set and a registration position and shape data set, respectively, of the group can be regarded as being “good” in terms of registration accuracy and/or registration time. For determining the recommendations the evaluation unit 18 can be further adapted to determine the registration image data set, the registration position and shape data set or the combination of a registration image data set and a registration position and shape data set of the determined group being most similar to the registration image data set, registration position and shape data set or combination of a registration image data set and a registration position and shape data set, respectively, provided by the registration input providing unit 17, wherein the most similar registration image data set, registration position and shape data set or combination of a registration image data set and a registration position and shape data set, respectively, can be recommended. The most similar registration image data set, registration position and shape data set or combination of a registration image data set and a registration position and shape data set, respectively, can be determined by using a similarity measure applied to a) the provided registration image data set, the provided registration position and shape data set or the provided combination of a registration image data set and a registration position and shape data set, respectively, and b) the respective registration image data set, registration position and shape data set or combination of a registration image data set and a registration position and shape data set of the determined group. If in an embodiment the registration image data sets comprise registration images showing the registration object and the catheter 12, respectively, and if the position and shape data sets comprise positions data sets defining positions of different parts of the registration object and the catheter 12, respectively, in order to define positions and shapes of the registration object and the catheter 12, respectively, the similarity measure may be based on distances between a) the registration object shown in the respective registration image of the group and b) the catheter 12 shown in the provided registration image and/or between a) registration positions and shapes of the determined group and b) the registration position and shape of the catheter 12.

The interventional system 1 further comprises an output unit 26 being, in this embodiment, a display. The determined recommended registration image data set and/or registration position and shape data set can be shown on the display 26, in order to allow a user to use the determined recommended registration image data set and/or the determined recommended registration position and shape data set for the registration, i.e. the user may position and shape the catheter 12 via the navigation unit 13 and control the x-ray projection system 2 via the imaging control unit 10 such that a registration image in accordance with the recommended registration image data set can be generated by the x-ray projection system 2, while the catheter 12 has a position and shape in accordance with the recommended registration position and shape data set. For instance, if the recommended registration image data set comprises a recommended registration image showing the registration object and if the recommended position and shape data set comprises a positions data set defining recommended positions of different parts of the registration object, in order to define a recommended position and shape of the catheter 12, the recommended registration image and/or the recommended position and shape of the catheter 12 may be shown on the display 26.

The evaluation unit 18 can be adapted to output the determined recommended registration image data set and/or the determined recommended registration position and shape data set also directly to the imaging control unit 10 and/or to the navigation unit 13, in order to allow the imaging control unit 10 to control the x-ray projection system 2 and/or to allow the navigation unit 13 to control the shape of the catheter 12 in accordance with the determined recommended registration image data set and/or registration position and shape data set for the registration.

The evaluation unit 18 may also be adapted to determine several recommended registration image data sets and/or several recommended position and shape data sets of the catheter 12 based on the database such that the evaluated registration accuracy is increased and the registration time is decreased, wherein the determined recommended registration image data sets and/or registration position and shape data sets can be shown on the display 26. The evaluation unit 18 can be further adapted to provide a user interface for allowing the user to select a recommended registration image data set and/or a recommended registration position and shape data set, wherein the selected recommended registration image data set and/or the selected recommended registration position and shape data set can be provided to the imaging control unit 10 and/or to the navigation unit 13 for allowing the imaging control unit 10 and/or the navigation unit 13 to control the x-ray projection system 2 and/or the catheter 12 in accordance with the selected recommended registration image data set and/or the selected recommended registration position and shape data set. For instance, if the selected recommended registration image data set comprises a selected recommended registration image showing the registration object and if the selected recommended position and shape data set comprises a positions data set defining recommended positions of different parts of the registration object, in order to define a recommended position and shape of the catheter 12, the navigation unit 13 can be adapted to modify the catheter 12 such that it has the recommended registration position and shape. Moreover, the navigation unit 13 can position the catheter 12 and the imaging control unit 10 can position the x-ray source 5 and the x-ray detector 3 such that the recommended registration image is obtained.

The assisting apparatus 20 further comprises a structural information providing unit 19 for providing structural information of the person 8. The evaluation unit 18 can be adapted to determine the recommended registration image data set and/or the recommended registration position and shape data set also depending on the provided structural information. The structural information is, for instance, a segmented CT image or another image showing an inner structure of the person 8, wherein the catheter 12 should be navigated within the inner structure. For instance, the evaluation unit 18 can be adapted to determine the recommended registration image data set and/or the recommended registration position and shape data set such that the catheter 12 is locatable within the inner structure during the registration process. For instance, the evaluation unit 18 can be adapted to determine the most similar registration image data set and/or registration position and shape data set of a group of registration image data sets and/or registration position and shape data sets, to which registration values have been assigned which are larger than a predefined threshold, which correspond to a position and shape of the catheter 12 within the inner structure defined by the provided structural information.

The database 16 may be further adapted such that the registration values can be provided further depending on a registration parameter, wherein the registration input providing unit 17 may be adapted to also provide the registration parameter and the evaluation unit 18 may be adapted to evaluate the accuracy of registering the x-ray projection device 2 and the position and shape determination device 15 to each other also based on the provided registration parameter. The registration parameter may be a parameter being indicative of the kind of the first object, which should be used for performing the registration. For instance, the registration parameter can be indicative of whether the object used for the registration is a catheter or a guidewire. Moreover, the registration parameter may be indicative of the part of the person 8, into which the catheter 12 should be introduced for the registration. For instance, the registration parameter can define a certain organ of the person, in which the catheter 12 should be present during the registration. Thus, the registration may not only be evaluated based on a provided registration image data set and/or a provided registration position and shape data set, but the evaluation can also be based on further parameters, i.e. based on the registration parameters. The evaluation unit 18 can also be adapted to determine a recommended registration parameter based on the database 16 such that the evaluated registration accuracy and/or the evaluated registration time are improved.

In particular, the database 16 can comprise assignments between i) registration values and ii) combinations of a) registration parameters and b) registration image data sets, registration position and shape data sets or combinations of a registration image data set and a registration position and shape data set. Thus, based on a) a provided registration parameter and b) a provided registration image data set, a provided registration position and shape data set or a provided combination of a registration image data set and a registration position and shape data set a registration value can be provided by the database 16, wherein this registration value can be used for evaluating the provided combination of a) the registration parameter and b) the registration image data set, the registration position and shape data set or the combination of a registration image data set and a registration position and shape data set. Moreover, since the registration values stored in the database 16 are indicative of the registration accuracy and/or the registration time, the assignments between the registration values and the combinations of a) the registration parameters and b) the registration image data sets, the registration position and shape data sets or the combinations of a registration image data set and a registration position and shape data set can be used for recommending a certain combination of a) a registration parameter and b) a registration image data set, a registration position and shape data set or a combination of a registration image data set and a registration position and shape data set. For instance, if a certain registration parameter and a certain combination of a registration image data set and a registration position and shape data set are provided by the registration input providing unit 17, the evaluation unit 18 can determine the most similar combination of a registration image data set and a registration position and shape data set, which has been stored for the provided registration parameter in the database 16, having a registration value being larger than a predefined threshold as the recommended combination of a registration image data set and a registration position and shape data set.

In this embodiment the registration input providing unit 17 is adapted to provide a registration image data set including a registration image generated by the x-ray projection system 2 and to provide a registration position and shape data set including a positions data set defining positions of different parts of the catheter 12, in order to define the registration position and shape of the catheter 12 as determined by the position and shape determination device 15. The registration input providing unit 17 can therefore also be regarded as being a registration image providing unit and a registration position and shape providing unit. Moreover, since the registration input providing unit 17 is also adapted to provide a registration parameter, the registration input providing unit 17 can also be regarded as being a registration parameter providing unit.

The interventional system 1 further comprises a registration unit 21 for registering the provided registration image and the provided registration position and shape to each other, thereby generating a registration result, and a registration value determination unit 22 for determining a registration value based on the registration of the provided registration image and the provided registration position and shape, wherein the registration value is indicative of the registration accuracy and/or the time required for the registration. The interventional system 1 further comprises a database generation unit 23 for generating the database 16 based on the determined registration value, the provided registration image and the provided registration position and shape. The database generation unit 23 is preferentially also adapted to consider a provided registration parameter like the type of the registration object, for instance, whether the registration object is a catheter or a guidewire, while generating the database. A registration value assigned to a certain registration position and shape can be determined depending on the registration values assigned to combinations of this certain registration position and shape with several registration images. For instance, the registration values assigned to the combinations of the certain registration position and shape with the several registration images can be averaged for determining the registration value for the certain registration position and shape, i.e. to a registration position and shape data set including the certain registration position and shape. Correspondingly, a registration value assigned to a certain registration image can be determined depending on the registration values assigned to combinations of this certain registration image with several registration positions and shapes. For instance, the registration values assigned to the combinations of the certain registration image with the several registration positions and shapes can be averaged for determining the registration value for the certain registration image, i.e. to a registration image data set including the certain registration image.

The registration unit 21 can be adapted to register the provided registration image and the provided registration position and shape by, for instance, translating, rotating and/or deforming the registration image and/or the registration position and shape such that a similarity measure applied to the registration image and to a projection of the registration position and shape onto the registration image is optimized. The registration value determination unit 22 can be adapted to determine the respective registration value based on the optimized similarity measure, wherein the determined registration value can be assigned to the provided registration image and the provided registration position and shape and optionally also to a provided registration parameter, wherein the resulting assignments can be stored in the database 16. The similarity measure can be based on distances between the registration object shown in the provided registration image and a calculated projection of the registration position and shape of the registration object onto the provided registration image. The registration value determination unit 22 can be adapted to determine the registration values also based on the time needed for the registration performed by the registration unit 21. In particular, a registration value can be determined as a combination, for instance, a linear combination, of the optimized similarity measure and the time needed for the registration.

Instead of or as an alternative to automatically determining the registration values, in an embodiment the registration value determination unit 22 can be adapted to show the registration result as an overlay of the provided registration position and shape projected onto the provided registration image and the provided registration image on the display 26, to provide a user interface allowing a user to input similarity information being indicative of a degree of similarity between the registered registration image and the registered projected registration shape and to determine the registration value based on the input similarity information. For instance, the user interface provided by the registration value determination unit 22 can be adapted to allow a user to rate the registration result, wherein this rate can directly be the registration value or the registration value can depend on the input rate.

The registration input providing unit 17, the registration unit 21, the registration value determination unit 22 and the database generation unit 23 can be regarded as being components of a database generation apparatus for generating the database 16 to be used by the assisting apparatus 20. This database generation apparatus can be integrated in another system, for instance, in the interventional system 1, as schematically and exemplarily shown in FIG. 1, or the database generation apparatus can be a standalone apparatus.

The interventional system 1 further comprises an output determining unit 24 for determining at least one registration image data set and/or at least one registration position and shape data set of the database 16 to be shown on the display 26 depending on the registration values assigned to the registration image data sets and/or registration position and shape data sets of the database 16. For instance, the output determining unit 24 can be adapted to determine registration image data sets and/or registration position and shape data sets, to which registration values have been assigned, which are larger than a predefined threshold, in order to determine the “good” registration image data sets and/or registration position and shape data sets in terms of registration accuracy and/or registration time. These “good” registration image data sets and/or registration position and shape data sets may be shown on the display 26, in order to show to a user which registration image data sets and/or which registration position and shape data sets lead to an accurate registration and/or to short registration times. By showing these good examples, the user can be taught. The database 16 and the output determining unit 24 can therefore be regarded as being components of a teaching apparatus for teaching a user in registering the x-ray projection system 2 with the position and shape determination device 15. Although in this embodiment the teaching apparatus is integrated in the interventional system 1, in other embodiments the teaching apparatus can also be integrated into another system or it can be a standalone apparatus. The predetermined threshold used for determining the “good” registration image data sets and/or registration position and shape data sets in terms of registration accuracy and/or registration time can be predetermined by calibration. Moreover, in an embodiment the threshold for determining “good” registration image data sets and/or registration position and shape data sets in terms of registration accuracy and/or registration time can be input by a user.

The output determining unit 24 can be adapted to determine at least one registration image data set and/or at least one registration position and shape data set to be shown on the display 26 also depending on a provided registration parameter, because in the database 16 the registration image data sets and/or the registration position and shape data sets are preferentially also related to registration parameters like the kind of the registration object, for instance, whether the registration object is a catheter or a guidewire. Thus, good examples of registration image data sets and/or registration position and shape data sets may also be shown on the display 26 depending on the respective registration parameter.

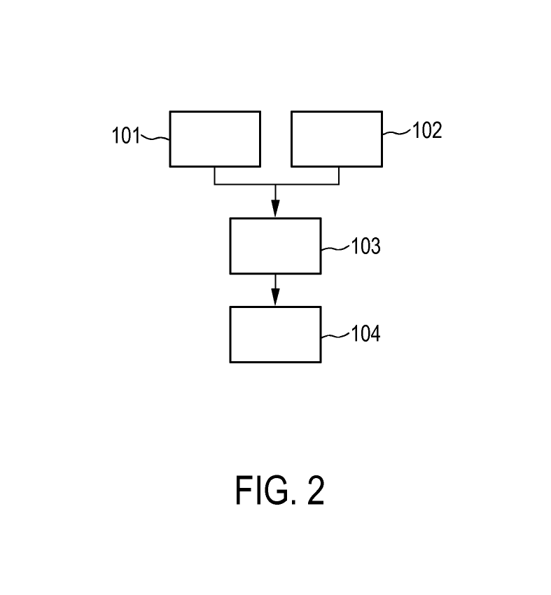

In the following an embodiment of an assisting method for assisting in registering the x-ray projection system 2 with the position and shape determination device 15, wherein the x-ray projection system 2 generates a registration image of the catheter 12, while the catheter 12 is in a registration position and has a registration shape, and wherein the position and shape determination device 15 is adapted to determine the registration position and the registration shape, is exemplarily described with reference to a flowchart shown in FIG. 2.

In step 101 a registration image data set being indicative of the registration image generated by the x-ray projection system 2 and a registration position and shape data set being indicative of the registration position and shape determined by the position and shape determination device 15 are provided to the evaluation unit 18. In step 102 the database 16 is provided. The database 16 is adapted to provide registration values depending on registration image data sets being indicative of registration images showing a registration object having the same spatial configuration as the catheter 12 and/or registration position and shape data sets being indicative of registration positions and shapes of the registration object, wherein the registration values are indicative of the registration accuracy and/or the time required for the registration, if a registration image of the registration object in accordance with the respective registration image data set and/or a registration position and shape data set in accordance with the respective registration position and shape of the registration object is used for the registration. In step 103 the evaluation unit 18 evaluates the registration accuracy and/or the time required for the registration based on registration values provided by the database 16 depending on the provided registration image data set being indicative of the registration image showing the catheter 12 and/or the provided registration position and shape data set being indicative of the registration position and shape of the catheter 12. In step 104 the registration accuracy and/or the time required for the registration are indicated on the display 26.

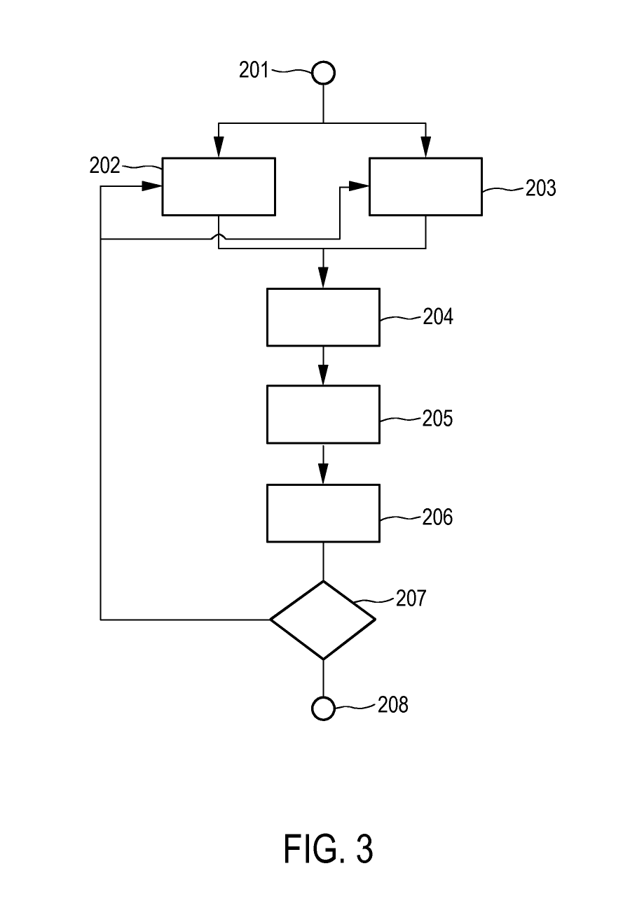

In the following an embodiment of a database generation method for generating the database 16 will exemplarily be described with reference to a flowchart shown in FIG. 3.

In step 201 the database generation method starts, for instance, the database generation apparatus is switched on. In step 202 a registration image generated by the x-ray projection system 2 is provided by the registration image providing unit 17, wherein the registration image shows the catheter 12, while the catheter 12 has a registration position and shape. The registration image is in accordance with a registration image data set. For instance, the registration image data set comprises the registration image and/or the registration image data set comprises imaging parameters like the acquisition direction, the amount of radiation et cetera used for generating the registration image. In step 203 the registration input providing unit 17 provides the registration position and shape of the catheter 12 as determined by the position and shape determination device 15. The registration position and shape is in accordance with a registration position and shape data set. For instance, the registration position and shape data set can comprise a positions data set defining the registration position and shape by defining positions of different parts of the catheter 12 and/or position and shape parameters being indicative of the registration position and shape determination. In step 204 the provided registration image and the provided registration position and shape are registered to each other by the registration unit 21 and in step 205 the registration value determination unit 22 determines a registration value based on the registration, wherein the registration value is indicative of the registration accuracy and/or the time required for the registration. In step 206 a database generation unit 23 generates the database 16 based on the determined registration value, the provided registration image data set and/or the provided registration position and shape data set, in particular, the database generation unit 23 adds the determined registration value, the registration image and/or the provided registration position and shape to an already existing database 16 in order to update the same. In step 207 it is determined whether further registration images and/or registration shapes should be used for updating the database 16. For instance, it can be determined whether further registration images and/or further registration shapes are stored in the registration input providing unit 17, which should be used for updating the database 16. If this is the case, the database generation method continues with steps 202 and 203. Otherwise, the database generation method ends in step 208.

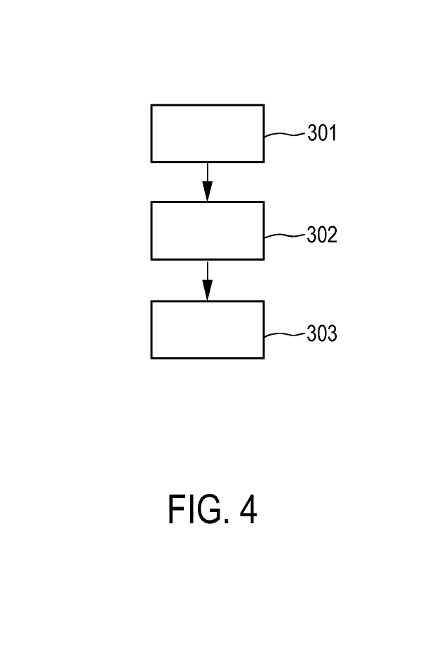

In the following an embodiment of a teaching method for teaching a user in registering the x-ray projection system 2 with the position and shape determination device 15 will exemplarily be described with reference to a flowchart shown in FIG. 4.

In step 301 the database 16 is provided and in step 302 at least one registration image data set and/or at least one registration position and shape data set, which should be displayed on the display 26, is determined by the output determining unit 24 depending on a registration value provided for the at least one registration image data set and/or the at least one registration position and shape data set by the database 16. In step 303 the determined at least one registration image data set and/or the determined at least one registration position and shape data set are shown on the display 26. Thus, for instance, on the display 26 only registration image data sets and/or registration position and shape data sets can be shown, to which registration values have been assigned, which are larger than a predefined threshold, in order to show to the user only good registration image data sets and/or registration positions and shape data sets in terms of registration accuracy and/or registration time. If the database 16 can provide the assignments between the registration values and the registration image data sets and/or the registration position and shape data sets also depending on a registration parameter like the kind of object used for the registration, the good registration image data sets and/or registration position and shape data sets can also be displayed on the display 26 depending on a corresponding respective input registration parameter. For example, for a guidewire other good registration image data sets and/or registration position and shape data sets may be shown than for a catheter.

The position and shape determination device 15 is preferentially adapted to provide three-dimensional position and shape information by using OSS. For this reason the catheter 12 is OSS-enabled by equipping the catheter 12 with an OSS fiber, wherein the position and shape information determined by OSS can be used in a medical intervention for assisting in navigating the catheter 12 within the person 8. The interventional system 1 described above with reference to FIG. 1 is adapted to perform an interventional x-ray application, wherein the OSS data should be used together with the x-ray images generated by the x-ray projection system 2. For this reason the position and shape determination device 15 is registered with the x-ray projection system 2 by using the registration unit 21.

The accuracy of three-dimensional OSS to x-ray image registration is dependent on a number of factors such as the characteristics of the OSS-enabled device, the curvature of the OSS fiber, the length of the device segment visible in the x-ray image, the quality of the x-ray images, the number and the acquisition angles, i.e. the acquisition directions, of the generated x-ray images, patient attributes, et cetera. Generally, these factors may not always be optimally satisfied in an interventional setting during a registration procedure. If these factors or other factors defining the registration are not optimally satisfied, a relatively long conversion time of the registration procedure and/or an inaccurate registration may result. For this reason the interventional system 1 comprises the assisting apparatus 20, which may be regarded as being a feedback and recommendation system to assist the user to complete the OSS shape to x-ray registration as quickly and correctly as possible. The assisting apparatus comprises the database of registration position and shape data sets, registration image data sets and registration-position-and-shape-data-set/registration-image-data-set combinations. A registration position and shape data set can include a) a positions data set defining positions of different parts of the registration object for defining a registration position and shape and/or b) position and shape parameters being indicative of, for instance, the curvature, the stability, the jitter, the motion or other characteristics of the registration position and shape of the registration object. A registration image data set can include a) a registration image and/or b) imaging parameters like the length of the registration object in the registration image, the quality of the registration image, which may be determined as the signal-to-noise ratio or by another measure, the acquisition direction used for generating the registration image, et cetera. A registration image data set can also include several registration images, which have been acquired in different acquisition directions, and the acquisition directions used for generating the several registration images. The database can further comprise registration parameters including patient attributes. To each database item a registration value being indicative of the registration accuracy and/or the registration time can be associated. The assisting apparatus preferentially provides feedback on the quality of, for instance, the position and shape input for registration. For example, position and shapes with low curvatures may not be suitable for registration and the user can be warned against this. Similarly, a moving position and shape may not be suitable as the jitter in position and shape and the artifacts in x-ray images increase during such motion.

The assisting apparatus preferentially provides feedback on the characteristics of the image input, i.e. the characteristics of the provided registration image. This can be about the number of x-ray registration images, the angles of the x-ray registration images, and the sufficiency of the visible length of the catheter in the x-ray registration image. For example, if a single x-ray registration image should be used for the registration, the assisting apparatus can warn the user that this may result in an inaccurate registration regarding the angles, which do not correspond to the single view. In particular, if it is evaluated that a provided registration image data set including a single registration image leads to relatively low registration accuracy, another registration image data set of the database comprising several registration images can be recommended leading to better registration accuracy. The assisting apparatus is preferentially adapted to provide a visual recommendation on how to improve the registration. For instance, the assisting apparatus can be adapted to show a visual library of x-ray images, i.e. of registration images of registration image data sets, where the position of the device within the registration image, i.e. of the registration object which might be a catheter or a guidewire, is most convenient for the registration algorithm, i.e. to which registration values have been assigned being larger than a predefined threshold. This library, which is stored in the database, can be visualized by the operator before the registration procedure as well. The assisting apparatus may be adapted to automatically choose only several x-ray images, i.e. only several registration images, from the library of images contained in the database based on the provided input x-ray image. The chosen several x-ray images are the images of the library, which are closest to the provided input. The assisting apparatus can therefore guide the user to quickly find a new more favorable x-ray image, i.e. a more favorable configuration of the x-ray projection system 2 and position and shape of the catheter 12 such that a recommended registration image can be generated, with the least effort from the current position.

The database can comprise a position and shape library of favorable positions and shapes for registration, i.e. of registration positions and shapes of position and shape data sets having registration values being larger than a predefined threshold. The whole library can be presented to the user as images. Alternatively, the assisting apparatus can show the position and shape, i.e. the registration position and shape, being the closest one with respect to the current provided registration position and shape. The assisting apparatus can be further adapted to show the closest favorable positions and shapes with a visual guidance on how to modify the current registration position and shape to match a recommended registration position and shape. For instance, it can be shown on the display in which direction the catheter should be moved and how the catheter should be shaped such that it reaches the recommended position and shape.

In a robotic application the assisting apparatus can provide commands to the robot to modify the current position and shape to a recommended position and shape for registration. The assisting apparatus can be adapted to provide a list of closest favorable registration positions and shapes and the user may choose the position and shape which should be achieved by the robot. The closeness can be defined by a similarity measure to be applied to the current position and shape and the good positions and shapes, i.e. the favorable positions and shapes, stored in the database, wherein the similarity measure can be based on squared distances between the current position and shape and the respective position and shape of the database. The closeness can optionally further be defined by calculating a cost of moving from the current position and shape to the ideal position and shape. The cost may depend on the distance the catheter has to travel to reach the ideal, i.e. recommended, position and shape, wherein a larger distance corresponds to larger costs.

The assisting apparatus can also be adapted to provide recommendations customized to the type and name of the first object. For instance, the recommendations can differ between an OSS catheter and an OSS guidewire. The recommendations can also depend on the respective first object by using a corresponding calibration file, which may be regarded as being a device calibration file and in which registration parameters like the type of a catheter, the name of the catheter, the thickness of the catheter, et cetera can be stored. In order to provide these customized recommendations, the database can be adapted to provide registration values also depending on the registration parameters. The calibration file may also comprise position and shape parameters like a parameter being indicative of the expected quality, i.e., for instance, expected accuracy, of the determined position and shape, which may be known from a previous device testing procedure.

The assisting apparatus is preferentially also adapted to provide recommendation and feedback for a semi-automatic registration of OSS to x-ray. In this case the assisting apparatus may provide recommendations on the number of clicks, the distance between the clicks, the positions of the clicks, et cetera on a registration image, wherein these clicks, i.e. the corresponding indications on the registration image, are used for identifying the first object in the registration image, wherein the identified first object is used for registering the x-ray projection system with the position and shape determination device. In order to allow the assisting apparatus to provide also this kind of recommendation, the additional registration parameters stored in the database may be the number of clicks, the distance between the clicks, the positions of the clicks, et cetera.

The assisting apparatus can be adapted to provide recommendations about the position and shape and image input, i.e. about the registration position and shape and the registration image to be used during the registration. The feedback about the process and the result of registration can include displaying various relevant parameters such as the processing time, success or failure, the reliability of the registration result measured as a function of the distance between the catheter in the x-ray image and the projection of the three-dimensional position and shape determined by the position and shape determination device 15 on the x-ray image, et cetera. The numerical results can also be presented visually, for instance, in a graphical form. For instance, to each item of the database a first registration value being indicative of the processing time and a second registration value being indicative of the accuracy of the registration can be assigned, wherein based on the first registration values an expected processing time can be determined and based on the second registration values it can be determined whether the registration will be successful or fail, for instance, by comparing the second registration values with a predefined threshold. The reliability of the registration result may be calculated by the assisting apparatus by calculating the distance between the catheter in the x-ray image and the projection of the three-dimensional position and shape determined by the position and shape determination device 15 on the x-ray image.

The assisting apparatus can be adapted to provide feedback regarding the position and shape and image input both before and after the registration. Before the registration the input position and shape and image may be analyzed and warnings about several parameters that may affect the registration may be presented. The same can be done after registration. Based on the registration result and automatically computed parameters feedback can be given over the most influential parameters that affect the registration.

The assisting apparatus preferentially provides an intuitive recommendation method which uses images and three-dimensional position and shape data. Before the deployment of the OSS application, the registration accuracy can be evaluated over a large set of images and positions and shapes stored in the database. The assisting apparatus can use the results from this evaluation to build a visual library of positions and shapes, images and position and shape/image combinations that can be most accurately registered. The visual library along with metadata can be stored in the database that is accessible to the application. In the library for each image, position and shape and/or combination of image and position and shape there can be one or more registration values, which may be numerical and/or categorical values, indicating how good that particular position and shape, image or position and shape/image combination is for registration.

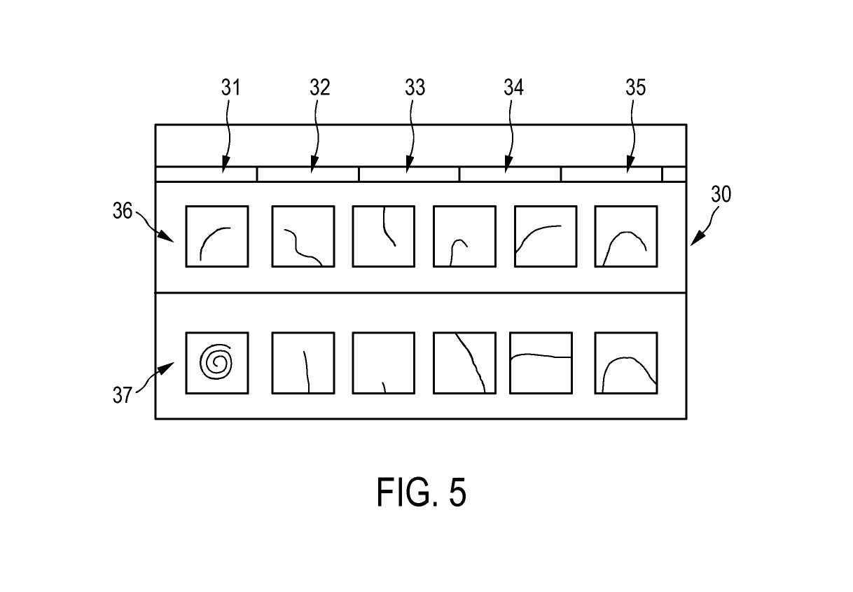

The visual library of x-ray images may be shown to the user, in order to train the user. The same can be done for the positions and shapes, i.e. the registration positions and shapes, and the combined position and shape and x-ray data, i.e. the combinations of the registration images and registration positions and shapes. The visual data can be presented depending on registration parameters defining, for instance, the kind of operation to be performed by the interventional system and/or the anatomical region, in which the registration should be performed. Also registration images, registration positions and shapes and/or combinations of a registration image and a registration position and shape, which would not lead to good registration results, can be presented, in order to show to the user which registration images, registration positions and shapes and/or combinations of a registration image and a registration shape and shape should not be used. FIG. 5 illustrates schematically and exemplarily a graphical user interface 30 showing good registration positions and shapes 36 and bad registration positions and shapes 37. These positions and shapes, which are positions and shapes of a guidewire, are shown, if the user has activated a first button 31. If the user activates a second button 32, good and bad registration positions and shapes of a catheter will be shown. If the user activates a third button 33, good and bad registration images will be shown and if the user activates a fourth button 34, good and bad combinations of a registration image and a registration position and shape will be shown. If the user activates a fifth button 35, it will be shown which kind of user clicks are good and which kind of user clicks are bad in terms of registration accuracy and/or registration time. For instance, the number of user clicks, the distances between user clicks, et cetera, can be visualized.

The assisting apparatus can be adapted such that, once the user initiates the registration, the input, in particular, the registration image and the registration position and shape which should be used for the registration, is evaluated and the registration result may be presented on the display 26 as an overlay of the input registration image and a projection of the input registration position and shape on the input registration image after registration along with the recommendations on how to modify the input for improving the registration. Input one or several registration images and an input registration position and shape may be compared with the data in the library of the database that are more favorable to registration. The closest favorable registration images and registration positions and shapes may be determined and these can be presented to the user, in order to allow the user to quickly select these favorable cases and move the catheter 12 and/or the x-ray projection system 2 such that the presented closest favorable one or several registration images and the closest favorable registration position and shape data can be obtained. The registration image and the registration position and shape selected by the user can be used to automatically calculate a configuration of the catheter 12, i.e. a position and shape of the catheter 12, wherein this configuration can be communicated to the navigation unit 13, which may be regarded as being a control unit of a robot for steering the catheter 12, in order to allow the navigation unit 13 to automatically move the catheter 12 to the preferred location and to bring the catheter 12 in the preferred shape.

The assisting apparatus is preferentially adapted such that the feedback and the recommendations are adjusted to the particular device or device combination, i.e. to the particular first object, that is in use. For instance, the feedback and the recommendations can be adjusted to whether the first object is a catheter or guidewire or a catheter-guidewire combination. Thus, the registration values of the database may depend on further registration parameters defining the kind of the first object. For instance, if the first object is a catheter-guidewire combination a registration image can be recommended, which shows the guidewire ahead of, i.e. distal to, the catheter, because such a registration image may result in a more accurate registration in comparison to a registration image showing the guidewire completely within the catheter. If at least the tip of the guidewire is not within the catheter, this tip may be accurately detected in the registration image during the registration procedure, which may result in a more accurate registration.

The registration parameters, on which the recommendations may depend, may also define the imaged anatomical region, in order to allow the assisting apparatus to adjust the recommendations to the imaged anatomical region. For example, the recommendations for a coronary region may be different from those for an abdominal region. Some viewing angles or some anatomical positions of the x-ray source and the x-ray detector may be more preferable than others for registration.

The registration parameters stored in the database can further be indicative of the kind of user input, which is required, if the registration is a semi-automatic registration. The user input is preferentially obtained by allowing a user to indicate in the registration image several image points showing the catheter 12. A quality check on the user input can help in increasing the likelihood of a good registration and can reduce the likelihood of requiring more user input. Preferred user inputs can be determined by conducting simulations on a large set of data. For instance, the simulation can reveal that the registration accuracy is relatively high, if two registration images are used, which have been acquired in two different acquisition directions, and if in both registration images three image points are indicated by the user. In this case a registration image data set can be generated, which includes the two registration images and the two acquisition directions, and to a combination of this registration image data set and a registration parameter defining that in each image the user should indicate three image points a relatively high registration value can be assigned. The assisting apparatus can be adapted to involve communication with the user as it can provide a visual, textural and/or numerical feedback and recommendation on how to improve the registration of the position and shape determination device to the x-ray projection device.

Although in the above described embodiments the position and shape determination device is adapted to determine the position and shape of the interventional instrument by using OSS, in other embodiments the position and shape determination device can also be adapted to determine the position and shape of the interventional instrument, for instance, of a catheter or a guidewire, by using other techniques.

Although in an above described embodiment recommended/favorable registration images and/or positions and shapes have been presented to a user, the assisting apparatus, method and computer program can also be adapted to just evaluate the registration accuracy and/or the time required for the registration based on registration values provided by the database depending on a given, i.e. provided, registration image data set being indicative of a registration image showing a first object and/or a given, i.e. provided, registration position and shape data set being indicative of a registration position and shape of the first object. For instance, the assisting apparatus, method and computer program can have as an input a given registration image data set and/or a given registration position and shape data set, which may be given by the registration input providing unit based on a registration image which has been generated by a user using the imaging device and/or a registration position and shape of the first object, which has been determined, after the user has arranged the first object in this position and shape, respectively, wherein the registration accuracy and/or the time required for the registration may automatically be evaluated based on registration values provided by the database depending on the given registration image data set and/or the given registration position and shape data set, respectively.

Although in above described embodiments the first object is a longish object like a catheter or a guidewire, in other embodiments the first object can also be an object having another shape. In particular, the first object can be any object, which is imageable by the imaging device and of which the position and shape can be determined by the position and shape determination device.

Although in an above described embodiment from the database the closest registration image data set, registration position and shape data set or combination of a registration image data set and a registration position and shape data set, respectively, is determined by using a similarity measure, wherein the registration value assigned to the determined closest item of the database is used for determining the registration accuracy and/or the registration time, in other embodiments the database can be adapted such that the registration accuracy and/or the time required for the registration can be determined without using a similarity measure. For instance, the database can be adapted to provide registration values depending on curvatures and to determine the curvature of the first object from the provided registration image data set and/or from the provided registration position and shape data set, in order to allow the database to provide the registration values depending on registration image data sets and/or position and shape data sets via the determination of a curvature. The database can also be adapted to provide the registration values depending on registration image data sets and/or registration position and shape data sets via other parameters, especially other shape related parameters, which can be determined based on a registration image data set and/or a registration position and shape data set.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the provision of the database, the evaluation of the registration accuracy and/or the registration time, the determination of a recommended registration image and/or a recommended registration position and shape, the registration of the imaging device with the position and shape determination device, the generation of the database, et cetera performed by one or several units or devices can also be performed by any other number of units or devices. These procedures and/or the control of the assisting apparatus in accordance with the assisting method and/or the control of the teaching apparatus in accordance with the teaching method and/or the control of the database generation apparatus in accordance with the database generation method can be implemented as program code means of a computer program and/or as dedicated hardware.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

The invention relates to an assisting apparatus for assisting in registering an imaging device like an x-ray C-arm device with a position and shape determination device like an OSS device. The apparatus comprises a database providing registration values depending on registration image data sets and/or registration position and shape data sets, wherein the registration values are indicative of registration accuracies and/or registration times. The apparatus further comprises an evaluation unit for evaluating the registration accuracy and/or the registration time based on an input registration image data set and/or position and shape data set by using the database. Thus, before, during and/or after a registration procedure the registration accuracy and/or the registration time can be evaluated, in order to assist in registering the imaging device with the position and shape determination device.

1. An assisting apparatus for assisting in registering an imaging device with a position and shape determination device, the imaging device being adapted to generate a registration image of a first object, while the first object is in a registration position and has a registration shape, the position and shape determination device being adapted to determine the registration position and shape of the first object, the assisting apparatus comprising:
a registration input providing unit for providing a registration image data set being indicative of a registration image showing the first object and/or for providing a registration position and shape data set being indicative of a registration position and shape of the first object,
a database for providing registration values depending on registration image data sets being indicative of registration images showing a registration object having the same spatial configuration as the first object and/or registration position and shape data sets being indicative of registration positions and shapes of the registration object, wherein the registration values are indicative of the registration accuracy and/or the time required for the registration, if a registration image of the registration object in accordance with the respective registration image data set and/or a registration position and shape of the registration object in accordance with the respective position and shape data set is used for the registration,
an evaluation unit for evaluating the registration accuracy and/or the time required for the registration based on registration values provided by the database depending on the provided registration image data set being indicative of the registration image showing the first object and/or the provided registration position and shape data set being indicative of the registration position and shape of the first object.

2. The assisting apparatus as defined in claim 1, wherein the evaluation unit is further adapted to determine a recommended registration image data set and/or a recommended registration position and shape data set based on the database such that the evaluated registration accuracy is increased and/or the evaluated time required for the registration is decreased.

3. The assisting apparatus as defined in claim 1, wherein the database comprises registration image data sets being indicative of registration images showing the registration object and/or registration position and shape data sets being indicative of the registration position and shape of the registration object, wherein the registration values are assigned to the registration image data sets and/or the registration position and shape data sets, wherein the evaluation unit is adapted to determine a recommended registration image data set and/or a recommended registration position and shape data set by:
determining a group of registration image data sets and/or of registration position and shape data sets of the database, wherein the group includes registration image data sets and/or registration position and shape data sets to which registration values have been assigned being larger than a predefined threshold,
determining the registration image data set and/or the registration position and shape data set of the determined group being most similar to the registration image data set and/or to the registration position and shape data set provided by the registration input providing unit,
recommending the determined registration image data set and/or the recommended registration position and shape data set.

4. The assisting apparatus as defined in claim 2, wherein the evaluation unit is adapted to output the determined recommended registration image data set and/or the determined recommended registration position and shape data set to an imaging control unit for controlling the imaging device and/or to a position and shape control unit for controlling the position and shape of the first object, respectively, in order to allow the imaging control unit to control the imaging device and/or to allow the position and shape control unit to control the position and shape of the first object in accordance with the determined recommended registration image data set and/or recommended registration position and shape data set for the registration.

5. The assisting apparatus as defined in claim 2, wherein the first object is adapted to be introduced into a second object, wherein the assisting apparatus further comprises a structural information providing unit for providing structural information of the second object, wherein the evaluation unit is adapted to determine the recommended registration image data set and/or the recommended registration position and shape data set also depending on the provided structural information.

6. The assisting apparatus as defined in claim 1, wherein the database is adapted such that the registration values can be provided further depending on a registration parameter, wherein the registration input providing unit is adapted to also provide the registration parameter and the evaluation unit is adapted to evaluate the accuracy of registering the imaging device and the position and shape determination device to each other also based on the provided registration parameter.

7. A database generation apparatus for generating a database to be used by the assisting apparatus as defined in claim 1, wherein the database generation apparatus comprises:
a registration position and shape data set providing unit for providing a registration position and shape data set and for providing a registration position and shape of a registration object, which is determined by a position and shape determination device and which is in accordance with the provided registration position and shape data set,
a registration image data set providing unit for providing a registration image data set and for providing a registration image, which is generated by an imaging device and which is in accordance with the registration image data set, wherein the registration image shows the registration object, while the registration object has the registration position and shape,
a registration unit for registering the provided registration image and the provided registration position and shape to each other,
a registration value determination unit for determining a registration value based on the registration of the provided registration image and the provided registration position and shape, wherein the registration value is indicative of the registration accuracy and/or the time required for the registration, and
a database generation unit for generating the database based on the determined registration value, the registration image data set and/or the registration position and shape data set.

8. A teaching apparatus for teaching a user in registering an imaging device with a position and shape determination device, the imaging device being adapted to generate a registration image of a first object, while the first object is in a registration position and has a registration shape, the position and shape determination device being adapted to determine the registration position and the registration shape of the first object, the teaching apparatus comprising:
a database for providing registration values depending on registration image data sets being indicative of registration images showing a registration object having the same spatial configuration as the first object and/or registration position and shape data sets being indicative of registration position and shapes of the registration object, wherein the registration values are indicative of the registration accuracy and/or the time required for the registration, if a registration image of the registration object in accordance with the respective registration image data set and/or a registration position and shape of the registration object in accordance with the respective position and shape data set is used for the registration,
an output determining unit for determining at least one registration image data set and/or at least one registration position and shape data set to be output depending on a registration value provided for the at least one registration image data set and/or the at least one registration position and shape data set.

9. An interventional system for applying an interventional procedure to a living being, the interventional system comprising:
an interventional instrument to be introduced into the living being for applying the interventional procedure,
an imaging device for imaging the interventional instrument within the living being,
a position and shape determination device for determining the position and shape of the interventional instrument within the living being, and
an assisting apparatus for assisting in registering the imaging device and the position and shape determination device to each other as defined in claim 1, wherein the interventional instrument is the first object.

10. An assisting method for assisting in registering an imaging device with a position and shape determination device, the imaging device being adapted to generate a registration image of a first object, while the first object is in a registration position and has a registration shape, the position and shape determination device being adapted to determine the registration position and the registration shape of the first object, the assisting method comprising:
providing a registration image data set being indicative of a registration image showing the first object and/or for providing a registration position and shape data set being indicative of a registration position and shape of the first object by a registration input providing unit,
providing a database for providing registration values depending on registration image data sets being indicative of registration images showing a registration object having the same spatial configuration as the first object and/or registration position and shape data sets being indicative of registration positions and shapes of the registration object, wherein the registration values are indicative of the registration accuracy and/or the time required for the registration, if a registration image of the registration object in accordance with the respective registration image data set and/or a registration position and shape of the registration object in accordance with the respective position and shape data set is used for the registration,
evaluating the registration accuracy and/or the time required for the registration based on registration values provided by the database depending on the provided registration image data set being indicative of the registration image showing the first object and/or the provided registration position and shape data set being indicative of the registration position and shape of the first object by an evaluation unit.

11. A database generation method for generating a database to be used by the assisting apparatus as defined in claim 1, wherein the database generation method comprises:
providing a registration position and shape data set and providing a registration position and shape of a registration object, which is determined by a position and shape determination device and which is in accordance with the provided registration position and shape data set, by a registration position and shape data set providing unit,
providing a registration image data set and providing a registration image, which is generated by an imaging device and which is in accordance with the registration image data set, by a registration image data set providing unit, wherein the registration image shows the registration object, while the registration object has the registration position and shape,
registering the provided registration image and the provided registration position and shape to each other by a registration unit,
determining a registration value based on the registration by a registration value determination unit, wherein the registration value is indicative of the registration accuracy and/or the time required for the registration, and
generating the database based on the determined registration value, the registration image data set and/or the registration position and shape data set by a database generation unit.

12. A teaching method for teaching a user in registering an imaging device with a position and shape determination device, the imaging device being adapted to generate a registration image of a first object, while the first object is in a registration position and has a registration shape, the position and shape determination device being adapted to determine the registration position and the registration shape of the first object, the teaching method comprising:
providing a database for providing registration values depending on registration image data sets being indicative of registration images showing a registration object having the same spatial configuration as the first object and/or registration position and shape data sets being indicative of registration position and shapes of the registration object, wherein the registration values are indicative of the registration accuracy and/or the time required for the registration, if a registration image of the registration object in accordance with the respective registration image data set and/or a registration position and shape of the registration object in accordance with the respective position and shape data set is used for the registration,
determining at least one registration image data set and/or at least one registration position and shape data set to be output depending on a registration value provided for the at least one registration image data set and/or the at least one registration position and shape data set by an output determining unit.

13. An assisting computer program for assisting in registering an imaging device with a position and shape determination device, the imaging device being adapted to generate a registration image of a first object, while the first object is in a registration position and has a registration shape, the position and shape determination device being adapted to determine the registration position and the registration shape, the assisting computer program comprising program code means for causing an assisting apparatus as defined in claim 1 to carry out the steps of the assisting method, when the assisting computer program is run on a computer controlling the assisting apparatus.

14. An database generation computer program for generating a database to be used by the assisting apparatus as defined in claim 1, the database generation computer program comprising program code means for causing a database generation apparatus to carry out the steps of the database generation method when the database generation computer program is run on a computer controlling the database generation apparatus.

15. An teaching computer program for teaching a user in registering an imaging device with a position and shape determination device, the imaging device being adapted to generate a registration image of a first object, while the first object is in a registration position and has a registration shape, the position and shape determination device being adapted to determine the registration position and the registration shape, the teaching computer program comprising program code means for causing a teaching apparatus to carry out the steps of the teaching method, when the teaching computer program is run on a computer controlling the teaching apparatus.
